(19) United States
(12) Patent Application Publication
(10) Pub. No.: US 2026/0365349 A1
(43) Pub. Date: Nov. 19, 2026

(54) Deployment Architecture for Carrier Platforms Configured to Transport and Release Multiple Aerial Vehicles

(71) Applicant: Ruslan Prysiazhnyi, Orlando, FL (US)

(72) Inventor: Ruslan Prysiazhnyi, Orlando, FL (US)

(21) Appl. No.: 19/686,975

(22) Filed: May 25, 2026

Related U.S. Application Data
(63) Continuation of application No. 19/206,747, filed on May 13, 2025.

(51) Int. Cl. B64U 80/82; B64U 10/60; B64U 70/20; B64U 80/30; B64U 101/18

(52) U.S. Cl. CPC B64U 80/82; B64U 10/60; B64U 70/20; B64U 80/30; B64U 2101/18; B64U 2201/20

(57) ABSTRACT

A deployment architecture for a carrier platform configured to transport and selectively deploy multiple aerial vehicles is disclosed. The system includes a carrier platform, a deployment mechanism, and one or more release interfaces configured to selectively release aerial vehicles during operation. In various embodiments, the deployment mechanism includes mechanical, electromechanical, servo-controlled, spring-loaded, or electronically actuated release systems. The deployment architecture may support sequential deployment, simultaneous deployment, staged deployment, remotely controlled deployment, mission-triggered deployment, or autonomous deployment. The aerial vehicles may be retained within internal compartments, external mounting structures, rail systems, or deployment interfaces. Deployment may occur while the carrier platform is stationary, moving, or in flight. The disclosed architecture improves deployment flexibility, operational reliability, and coordinated aerial vehicle deployment capabilities in contested operational environments.

### CROSS-REFERENCE TO RELATED APPLICATIONS

This application is a continuation of U.S. application Ser. No. 19/206,747, filed May 13, 2025, which claims the benefit of U.S. Provisional Application No. 63/650,933, filed May 23, 2024. The entire disclosures of the foregoing applications are incorporated herein by reference in their entireties.

### FIELD OF THE INVENTION

The present invention relates generally to unmanned aerial vehicle systems and, more particularly, to deployment and release architectures for carrier platforms configured to transport and selectively deploy multiple aerial vehicles.

### BACKGROUND OF THE INVENTION

Carrier platforms configured to transport deployable aerial vehicles require reliable deployment and release mechanisms capable of operating under dynamic mission conditions.

Conventional release systems may suffer from limited flexibility, inadequate deployment sequencing, susceptibility to mechanical failure, or inability to selectively release multiple aerial vehicles during operation.

In electronic warfare and contested operational environments, reliable deployment architecture becomes increasingly important to ensure mission continuity and coordinated aerial vehicle deployment.

Accordingly, there exists a need for improved deployment and release systems capable of selectively deploying multiple aerial vehicles from a carrier platform in a reliable and controllable manner.

### SUMMARY OF THE INVENTION

The present invention provides deployment architectures and release mechanisms for carrier platforms configured to transport and selectively deploy multiple aerial vehicles.

In certain embodiments, a carrier platform includes one or more deployment compartments, mounting interfaces, release rails, locking systems, or release actuators configured to retain and selectively deploy aerial vehicles during operation.

The deployment system may support sequential deployment, simultaneous deployment, staged deployment, mission-triggered deployment, remotely controlled deployment, or autonomous deployment.

In certain embodiments, the release mechanism includes mechanical, electromechanical, spring-loaded, servo-controlled, or electronically actuated release systems.

The deployment architecture may further support deployment during movement or flight of the carrier platform.

### BRIEF DESCRIPTION OF THE DRAWINGS

FIG. 1 illustrates a carrier platform configured to transport multiple deployable aerial vehicles.

FIG. 2 illustrates a selective deployment mechanism configured to release individual aerial vehicles.

FIG. 3 illustrates a staged deployment configuration.

### DETAILED DESCRIPTION

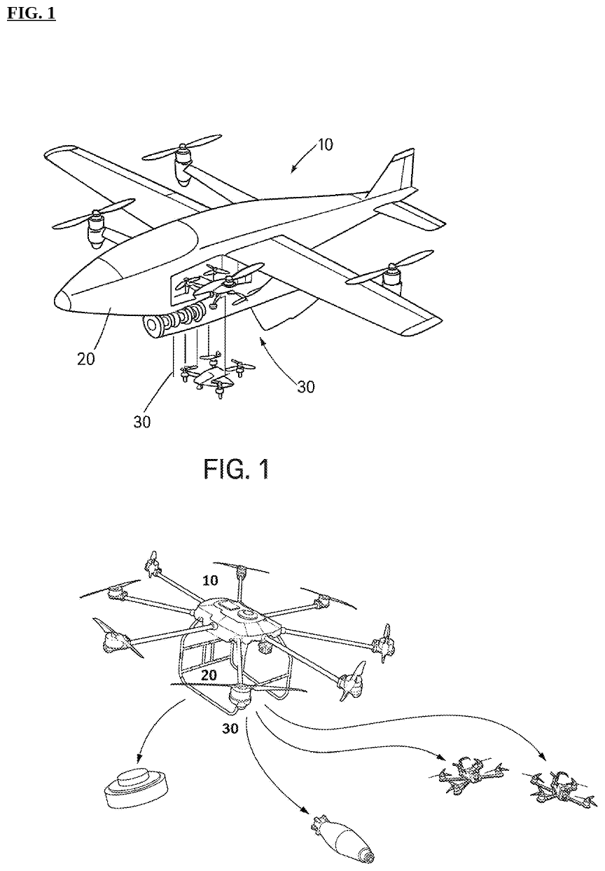

Referring to FIG. 1, a carrier platform 10 is configured to transport a plurality of deployable aerial vehicles 20.

The aerial vehicles 20 may be retained within one or more internal compartments, external mounting structures, rail systems, launch interfaces, or retention assemblies.

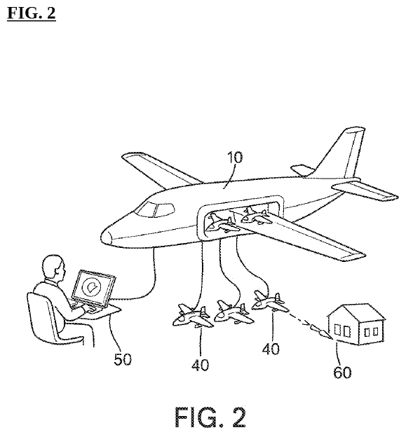

Referring to FIG. 2, deployed aerial vehicles 40 may be controlled by an operator 50 and may engage a designated target area 60.

The deployment mechanism 30 may include mechanical release assemblies, electromechanical actuators, servo-controlled release interfaces, spring-loaded release systems, or other deployment structures.

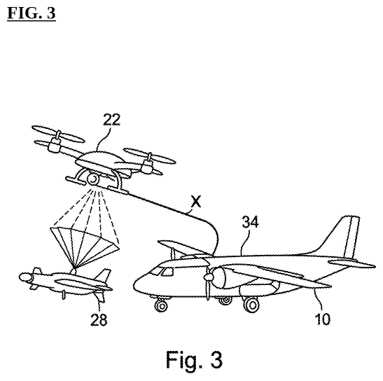

Referring to FIG. 3, an aerial vehicle 22 deploys a munition 28 while a severed tether X remains connected to fiber-optic line 34.

1. A deployment system comprising:
a carrier platform configured to transport a plurality of aerial vehicles; and
a deployment mechanism configured to selectively release one or more of the aerial vehicles during operation.

2. The system of claim 1, wherein the deployment mechanism includes a mechanical release assembly.

3. The system of claim 1, wherein the deployment mechanism includes an electromechanical actuator.

4. The system of claim 1, wherein the deployment mechanism includes a servo-controlled release interface.

5. The system of claim 1, wherein the deployment mechanism includes a controlled retention interface.

6. The system of claim 1, wherein the deployment mechanism includes a spring-loaded release system.

7. The system of claim 1, wherein the aerial vehicles are retained within an internal compartment.

8. The system of claim 1, wherein the aerial vehicles are mounted externally.

9. The system of claim 1, wherein the deployment mechanism supports sequential deployment.

10. The system of claim 1, wherein the deployment mechanism supports simultaneous deployment.

11. The system of claim 1, wherein the deployment mechanism supports staged deployment.

12. The system of claim 1, wherein deployment is remotely controlled.

13. The system of claim 1, wherein deployment is autonomous.

14. The system of claim 1, wherein deployment occurs during movement of the carrier platform.

15. The system of claim 1, wherein deployment occurs during flight.

16. The system of claim 1, further comprising a locking mechanism configured to secure the aerial vehicles prior to deployment.

17. The system of claim 16, wherein the locking mechanism is electronically controlled.

18. The system of claim 1, wherein the carrier platform is an unmanned aerial vehicle.

19. The system of claim 1, wherein the carrier platform is a ground vehicle.
